(19) United States
(12) Patent Application Publication
(10) Pub. No.: US 2012/0094391 A1
(43) Pub. Date: Apr. 19, 2012

(54) Biodegradable, disposable device for toilet training

(76) Inventor: Tammi Healani Sayuri Umeno, Mililani, HI (US)

(21) Appl. No.: 13/200,020

(22) Filed: Sep. 14, 2011

Related U.S. Application Data
(60) Provisional application No. 61/455,395, filed on Oct. 19, 2010.

(51) Int. Cl. G01N 21/80; G01N 21/78; B05C 11/00

(52) U.S. Cl. 436/163; 118/696; 422/400; 436/164

(57) ABSTRACT

Environmentally-friendly, disposable, water submersible device that turns translucent in the presence of urine and displays a visual indicator for toilet training.

This application claims the priority of U.S. provisional patent application No. 61/455,935 filed Oct. 19, 2010.

### TECHNICAL FIELD

The present invention relates to toilet training (potty training), and specifically to a biodegradable (environmentally-friendly) and disposable toilet training device that reveals a hidden design when directly or indirectly exposed to urine, and that can be used with a regular toilet.

### BACKGROUND ART

Parents and other caregivers of children expend substantial time, money and effort in teaching children how to go to the bathroom (urinate) in a toilet, also known as potty training or toilet training.

It is desirable to reduce the amount of time, effort and money spent on potty training by encouraging a child to urinate into a toilet by providing an immediate reward. It is also desirable to provide an incentive for a child to urinate at specific times, such as before going to sleep, so as to avoid urinating in the bed while asleep.

The toilet training market is full of products designed to encourage children to learn how to use the toilet, including such things as incentive stickers, charts, child-size pottys (toilets), potty seat adapters, potty step stools, potty training timers, diapers that become cool in temperature when wet, and pee targets for boys.

There are two products on the market that are relevant to the present invention. The first is a sticker that contains a hidden design that is revealed when wet. The sticker is placed on to the bottom of the flat area of a child's potty (a small toilet with no water). When the child urinates directly onto the surface of the sticker, a white and/or black top covering the sticker becomes transparent to reveal a picture. When the sticker becomes dry, the white and/or black covering becomes opaque. However, the child must urinate directly onto the sticker, otherwise the picture will not appear. The picture is also visible for only a short period of time, long enough for the child to rise up from the child's potty and be pleased with the result, before it fades back under the white and/or black cover. The sticker is re-useable, but the picture always remains the same. Parents can have a different picture revealed by peeling off the old, used sticker, and replacing it with a new one that contains a different picture on it. However, this product is not disposable and therefore unsanitary. Further, the sticker must be placed into a child's potty (with no water in it), as opposed to being usable with a normal toilet.

The second product is the pee target, which is marketed for boys. With the target, the picture is always visible and constitutes a target at which boys can aim while urinating. Unlike the present invention, in which a picture or design appears upon urination, there is no similar reward or incentive for the child to urinate, other than to hit the target.

Accordingly, it is an object of this invention to provide a device that is biodegradable, disposable, and usable in a normal toilet, where the picture that is revealed can be changed with each use.

It is a further object of the invention to provide a device that reveals a hidden picture or design, even if the child does not urinate directly onto the device.

It is still a further object of this invention to provide a device by which a child may create his or her own invisible design or picture, if desired.

### DISCLOSURE OF THE INVENTION

The above and other objects are achieved by a biodegradable, disposable, and water submersible potty training device that can be placed into the toilet bowl to provide a visual indicator (such as a picture, design, word or phrase) when in the presence of urine.

The device is preferably from a disposable film, such as paper, preferably blue pH paper (litmus paper),that is opaque when initially submerged in the water in the toilet bowl, so that a visual indicator marked thereon is hidden (invisible). However, in the presence of urine, the device changes visual characteristics, such as by becoming permanently translucent or a different color (a second color), so that the visual indicator becomes visible (is revealed). The visual indicator can be anything that appeals to children (for example, dinosaurs, trucks, pigs, turtles, hearts, stars, etc.).

The present invention is also preferably biodegradable and disposable (so it can be flushed down the toilet). This allows for the use of a new device, containing a different visual indicator (such as a picture, design, word or phrase), each time the child needs to urinate. By using a new device with different pictures or designs, a child always has a different surprise to which to look forward, which can be used for example, to encourage a child to urinate before sleeping. The present invention is small, light-weight, inexpensive, biodegradable and disposable. It can be used for both girls and boys.

The presently preferred embodiment of the invention is a device comprising a thin film, such as paper, having a color, front, and a back, that is opaque in the presence of water, but reacts to a condition in urine by becoming translucent or transparent. The thin film is preferably blue pH paper (litmus paper), which turns pink and translucent in the presence of urine. A visual indicator (such as a picture, design, word or phrase), that is the same color as the thin film, is preferably placed on the back of the thin film. A biodegradable backing can optionally be placed over the visual indicator on the back of the thin film. When the thin film is exposed to a condition of urine (such as pH or temperature), the thin film becomes translucent so that the opaque indicator can be seen through the front of the thin film.

The presently preferred embodiment of the invention is also a device comprising a thin film having a first color (such as blue), a front, and a back. The thin film is opaque in the presence of water, but reacts to a condition in urine by becoming a second color. A visual indicator of the first color is preferably placed on the front of the thin film. When the thin film reacts in the presence of urine to become the second color (such as pink), the visual indicator of the first color becomes visible on the front of the thin film by contrasting against the second color of the thin film.

The visual indicator (such as a picture, design, word or phrase) can be drawn or stenciled on the thin film using crayon, or stamped on the thin film using rubber stamps and an ink pad, as long as the crayon and ink are the same color as the thin film (before it is exposed to urine).

The visual indicator is also preferably placed on paper (by drawing, stamping, stenciling, or other methods, for example) using ink or crayon that is same color as the thin film, thereby forming a master. The master can then be printed, in a color that is the same as the thin film, onto the thin film by a color photocopy machine or color scanner, for example. The thin film can then be cut if necessary (using scissors or any other cutting means) into the desired size. In this manner, mass production is possible by placing multiple occurrences of the visual indicator on paper to form a master; printing the master in colo) on a sheet of thin film of the same color; and cutting the sheet of thin film to the desired size.

The visual indicator can also be preferably designed using a computer and a computer drawing program. The visual indicator can then be printed onto the thin film, in a color that is the same as the thin film, using a color printer that is operably connected to the computer. This way, mass production is also preferably achieved by designing multiple occurrences of the visual indicator using a computer and a computer drawing program; printing the multiple occurrences directly onto a sheet of thin film, in a color that is the same as the thin film, using a color printer that is operably connected to the computer; and cutting the sheet of thin film to the desired size.

The presently preferred embodiment of the invention is also a process for using a thin film of a first color having front and back surfaces, wherein the thin film is opaque in the presence of water, but reacts to a condition in urine by becoming a different color (second color) or translucent, and having a visual indicator of the first color placed on one of said surfaces comprising: placing the thin film into a toilet bowl; urinating into the toilet bowl so that the thin film becomes a different color (a second color) or translucent so the visual indicator is revealed; flushing the device down the toilet bowl; and wherein the process of using the thin film encourages children to urinate into said toilet bowl to reveal the visual indicator.

The presently preferred embodiment of the invention is also a toilet training device kit comprising: a thin film having a first color that is opaque in the presence of water, but reacts to a condition in urine by becoming a different color (a second color) or translucent; an indicator substance that is the same color as the thin film; a visual indicator that is created by placing said substance on said thin film (by drawing, stamping, stenciling, or other methods, for example); and wherein when the thin film is placed into a toilet and exposed to urine, the thin film becomes a different color (second color) or translucent so that the visual indicator is revealed.

### BRIEF DESCRIPTION OF DRAWINGS

FIG. 1(A) is a back view of the toilet training device of the present invention showing the back side of the thin film with the visual indicator placed thereon, before exposure to urine.

FIG. 1(B) is a back view of the backing that is placed over the visual indicator located on the back side of the thin film, before exposure to urine.

FIG. 1(C) is a front view of the front side of the completely assembled toilet training device, before exposure to urine.

FIG. 1(D) is a front view of the front side of the device where the thin film has become translucent from exposure to urine so that the visual indicator now shows through.

### BEST MODE FOR CARRYING OUT THE INVENTION

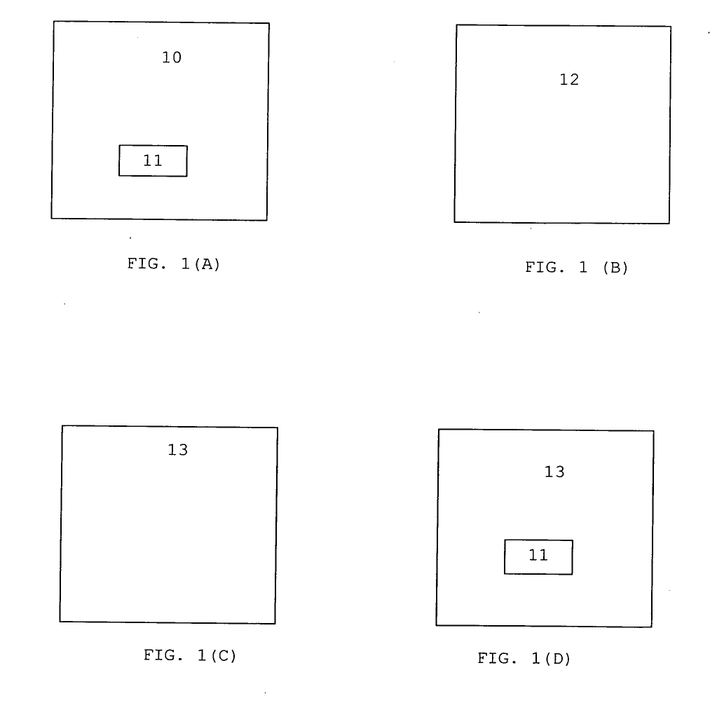

As shown in FIG. 1, the present invention uses a back surface of a thin film 10, wherein said thin film is preferably blue pH paper (litmus paper) that is made out of plant material. However, any thin film that changes visual characteristics, such as becoming translucent, transparent, or changing color in the presence of a condition in urine, such as pH, may be used. The thin film is preferably cut into 2×2, 3×3, or 4×4 inch squares, or 2, 3, or 4-inch diameter circles, but can be any shape or size that is not bigger than the water at the bottom of the toilet itself.

A visual indicator (design or picture) 11 is preferably placed on a surface, designating the back side of the thin film. The visual indicator can be any design or picture that appeals to young children (for example trucks, hearts, stars, teddy bears etc.). The design or picture can be applied using rubber stamps and a stamp pad containing ink of the same color as the blue pH paper. The present invention preferably uses a stamp pad made by Versa Magic in Aegean blue color. The design may also be drawn or stenciled on the back side of the thin film using crayon, preferably, Crayola brand cadet blue crayon.

Several devices can be mass produced at one time by preferably placing as many visual indicators as possible onto paper (such as 8×11 inch white paper) to form a master. The visual indicators can be applied by drawing, stamping, stenciling, or any other similar method, in a color that is the same color as the thin film (by preferably using the Versa Magic stamp pad in Aegean blue color or Crayola brand cadet blue crayon, for example). The master can then be printed in color onto the blue pH paper using a color photocopy machine or color scanner. Each visual indicator can then be cut to a desired size for use in the device.

The visual indicator can also be designed using a computer and a computer drawing program, and printed onto the thin film, in a color that is the same as the thin film, using a color printer that is operably connected to the computer. This way, mass production can also be achieved by designing multiple occurrences of the visual indicator using a computer and a computer drawing program, and printing the multiple occurrences directly onto the thin film, in a color that is the same as the thin film, using a color printer that is operably connected to the computer.

Preferably, the visual indicator may be applied in any manner using any product that does not allow the design or picture to be seen from the front or back of the device (described below) when dry or when wet (such as when the device is submerged in a toilet with no urine), but does allow the design to be seen through the device when the pH paper reacts with an acid in the water (such as urine).

Preferably, a biodegradable backing 12 is placed on the back of the device over the visual indicator 11 to provide contrast against which the visual indicator can be seen. The backing 12 is preferably self adhesive paper, such as a recycled, biodegradable, self-adhesive, laser printer label cut into the same shape and size as the thin film. However, any backing that can adhere to the back of the device to cover the design and provide contrast, and that is disposable, can be used.

As shown in FIG. 1(C), when the present invention is placed into the toilet with the backing facing down (and the front surface of the thin film is facing up 13), the device is opaque and the design or picture is hidden (invisible) because the neutral pH of the water does not chemically react with the thin film (pH paper). However, as shown in FIG. 1(D), when a child urinates in the toilet, either directly (on the device) or indirectly (within the vicinity of the device), the pH of the water decreases and the blue pH paper 13 turns pink and becomes translucent so that the visual indicator (design or picture) 11 is seen through the pH paper, contrasted against the backing 12.

While the present invention has been disclosed in connection with the presently preferred best mode described herein, it should be understood that there may be other embodiments which fall within the spirit and scope of the invention, as defined by the claims. Accordingly, no limitations are to be implied or inferred in this invention except as specifically and explicitly set forth in the claims.

### Industrial Applicability

The present invention discloses a biodegradable, disposable, water submersible toilet training device, and method of using the device, to encourage children to learn how to go to the bathroom in a toilet by providing an immediate reward for them.

1. A device comprising:
a thin film having a color, a front, and a back, that is opaque in the presence of water, but reacts to a condition in urine by becoming translucent;
a visual indicator placed on said back of said thin film, wherein said indicator is said color; and
wherein said thin film become translucent when exposed to said condition in urine so that said visual indicator becomes visible through said front of said thin film.

2. A device according to claim 1, further comprising a backing placed over said visual indicator on said back of said thin film.

3. A device comprising:
a thin film having a first color, a front, and a back, that is opaque in the presence of water, but reacts to a condition in urine by becoming a second color;
a visual indicator placed on said front of said thin film, wherein said indicator is said first color; and
wherein said thin film reacts when exposed to the presence of urine to become said second color so that said visual indicator becomes visible on said front of said thin film.

4. A device according to anyone of claim 1, 2 or 3, wherein said thin film is litmus paper.

5. A device according to anyone of claim 1, 2 or 3, wherein said condition of urine is pH.

6. A device according to anyone of claim 1, 2 or 3, wherein said indicator is placed on said thin film a method selected from the group consisting of drawing using crayon, stenciling using crayon, stamping using a rubber stamp and ink pad, photocopying using a color photocopy machine, or printing using a color printer.

7. A device comprising:
a thin film having a color, a front, and a back, that is opaque in the presence of water, but reacts to a condition in urine by becoming translucent;
a computer to design a visual indicator using a computer drawing program;
a color printer operably connected to said computer to print said visual indicator onto said thin film in said color; and
wherein said thin film reacts when exposed to urine to become translucent so that said visual indicator becomes visible through said front of said thin film.

8. A process of using a thin film of a first color having front and back surfaces, wherein said thin film is opaque in the presence of water, but reacts to a condition in urine by becoming a state selected from the group consisting of a second color or translucent, and having a visual indicator of said first color placed on one of said surfaces comprising:
placing said thin film into a toilet bowl;
urinating into said toilet bowl so that said thin film becomes said state so that said visual indicator is revealed;
flushing said thin film down said toilet bowl; and
wherein said process of using said thin film encourages children to urinate into said toilet bowl to reveal said visual indicator.

9. A toilet training device kit comprising
a thin film having a first color that is opaque in the presence of water, but reacts to a condition in urine by becoming a state selected from the group consisting of a second color or translucent;
an indicator substance that is said first color;
a visual indicator that is created by placing said substance on said thin film; and
wherein when said thin film is placed into a toilet and exposed to urine, said thin film becomes said state so that said visual indicator is revealed.
